(19) United States
(12) Patent Application Publication
(10) Pub. No.: US 2015/0191343 A1
(43) Pub. Date: Jul. 9, 2015

(54) Gas/Fuel Nozzle Holder

(71) Applicant: Kurtis Stephen Powers, Pompano Beach, FL (US)

(72) Inventor: Kurtis Stephen Powers, Pompano Beach, FL (US)

(21) Appl. No.: 14/148,733

(22) Filed: Jan. 7, 2014

(51) Int. Cl. B67D 7/42

(52) U.S. Cl. CPC B67D 7/42

(57) ABSTRACT

A portable mechanism that can be inserted into the rear portion of a gasoline-dispensing nozzle to automate the open position of that nozzle. This portable mechanism also disables the user from returning the gasoline-dispensing nozzle back into its resting cradle without removing the portable mechanism.

### FIELD OF THE INVENTION

This invention relates to the field of a gasoline pump portable mechanism and particularly to those portable mechanism that utilize the rear access of the gasoline pump handle lever in a open position for pumping gasoline.

### DESCRIPTION OF RELATED ART

U.S. Pat. No. 4,175,595 discloses a gasoline flow control device for regulating the flow of gasoline through a gasoline pump handle having a body with an upper and a lower spaced-apart surface thereon, the upper surface having a plurality of steps therein varying in distance from the lower surface on the body. Each step on the upper surface is concave in configuration and the lower surface includes a plurality of ridges and valleys cut therein forming an irregular surface thereon.

U.S. Pat. No. 4,201,253 discloses a gas pump lever blocking member including an elongated member with a first end adapted to engage the lever and a second end adapted to engage the lever guard in a plurality of positions corresponding to varying gas flow rates through the pump. The elongated member has a stepped portion proximate its second end defining a plurality of guard engagement surfaces lying in planes disposed along an elongation axis of the member.

U.S. Pat. No. 4,334,560 discloses a portable brace adjustable in length for retaining the trigger lever of a fuel dispensing nozzle in the open position and capable of easily disengaging in response to the shutoff actuating means of the nozzle.

U.S. Pat. No. 4,337,917 discloses a device that fits on a gasoline pump nozzle handle for holding the valve open, instead the need of continuously squeezing the handle in a hand; the device, in one design, including a collapsible brace for pressing against the handle.

U.S. Pat. No. 4,690,182 discloses a device to hold the lever of a nozzle assembly in a position to open a valve controlling the flow of fuel from the nozzle, e.g. a gasoline delivery nozzle assembly at a self-serve gasoline station.

U.S. Pat. No. 5,217,054 discloses an actuator for an automatic nozzle of a gasoline pump, the nozzle having a trigger operable within a housing which includes a trigger guard; the actuator having a spring member extending transversely of and supported on the trigger guard and engaging the trigger.

U.S. Pat. No. 5,240,226 discloses a fuel dispenser aid holding a trigger-like valve operating lever relative to a pistol grip-like handle portion of a valving device for dispensing gasoline or other fuels through a nozzle of the valving device without continuously manually holding the operating lever. The dispenser aid includes a mounting member formed of a material having a resilient, shape retaining character configured for mounting over the piston grip-like handle portion of the valving device, a flexible strap secured at a first end thereof to the mounting member and extending freely therefrom so that it can be looped under the trigger-like valve operating lever and up to the mounting member and an arrangement for releasably and adjustably fastening the free portion of the strap to the mounting member.

U.S. Pat. No. D 299,112 discloses a design for a brace for holding a gas pump nozzle in open position.

U.S. Pat. No. D 333,605 discloses a design for a gas pump nozzle trigger holder.

U.S. Pat. No. D 357,399 discloses a design for a combined gas pump nozzle lever holder and magnet.

### BACKGROUND OF THE INVENTION

Self-service gasoline stations gasoline-dispensing nozzles may not be equipped with a lock feature on the lever handle to maintain the flow of gasoline without continual manual holding of the lever during the fueling process.

The absence of a lever's lock may cause problems and is inconvenient for the customer during the fueling process. This leads to the need of having the ability to use a portable gas/fuel nozzle holder at self-service gas stations where the gasoline-dispensing nozzle lever has no built in lock feature.

### SUMMARY OF THE INVENTION

The intention of this invention is to provide a safe, inexpensive and easy portable mechanism that will enable a gasoline-dispensing nozzle's lever open in the event the normally equipped lock is broken or missing.

This portable mechanism will access the gasoline-dispensing nozzle from the rear portion and engage the gasoline-dispensing nozzle's lever handle in the open position without interfering with the auto shut-off fuel level feature inside the gasoline-dispensing nozzle.

This portable mechanism can be added too or taken out of the gasoline-dispensing nozzle during the fueling process at anytime the user chooses to do so.

This portable mechanism can be used time after time again in the event the user determines the need to be hands free during the fueling process on different occasions and independent of their fueling location.

This portable mechanism's location once inserted into the gasoline-dispensing nozzle will not allow the gasoline-dispensing nozzle to be placed onto its resting cradle after the fueling process is completed without the removal of the portable mechanism, thus ensuring the portable mechanism isn't left behind, forgotten and more importantly ensures the user has a safe fueling experience.

This portable mechanism inserted location also ensures the safe fueling experience for the next fueling user because the gasoline-dispensing nozzle can not be returned to the resting cradle thus ensuring the portable mechanism is removed by its current user preventing the event of a subsequent user finding a gasoline-dispensing nozzle lever being engaged without there knowledge.

This portable mechanism can be easily stored inside a vehicles gasoline access door or can be added to a key chain through a designated access hole.

### DESCRIPTION OF THE DRAWINGS

FIG. 1 is a side view of the fueling process, illustrating said invention engaged in the rear portion of a gasoline-dispensing nozzle.

FIG. 2 is a rear view of FIG. 1, illustrating the rear portion of a gasoline-dispensing nozzle without the said invention.

FIG. 3 is an enlarged side view of said invention as depicted by a dotted line engaged in the rear portion of a gasoline-dispensing nozzle.

FIG. 4 is an enlarged inside view of said invention engaged in the rear portion of a gasoline-dispensing nozzle.

FIG. 5 is a side view of the said end of the fueling process, illustrating the invention engaged in the rear portion of a gasoline-dispensing nozzle while trying to be put back into its resting cradle.

FIG. 6 is a side view of the said invention, also referred to as said gas/fuel nozzle holder and said portable mechanism.

### DESCRIPTION OF THE PREFERRED EMBODIMENTS

Referring now to the figures in greater detail, where like reference numbers designate like parts in the various figures.

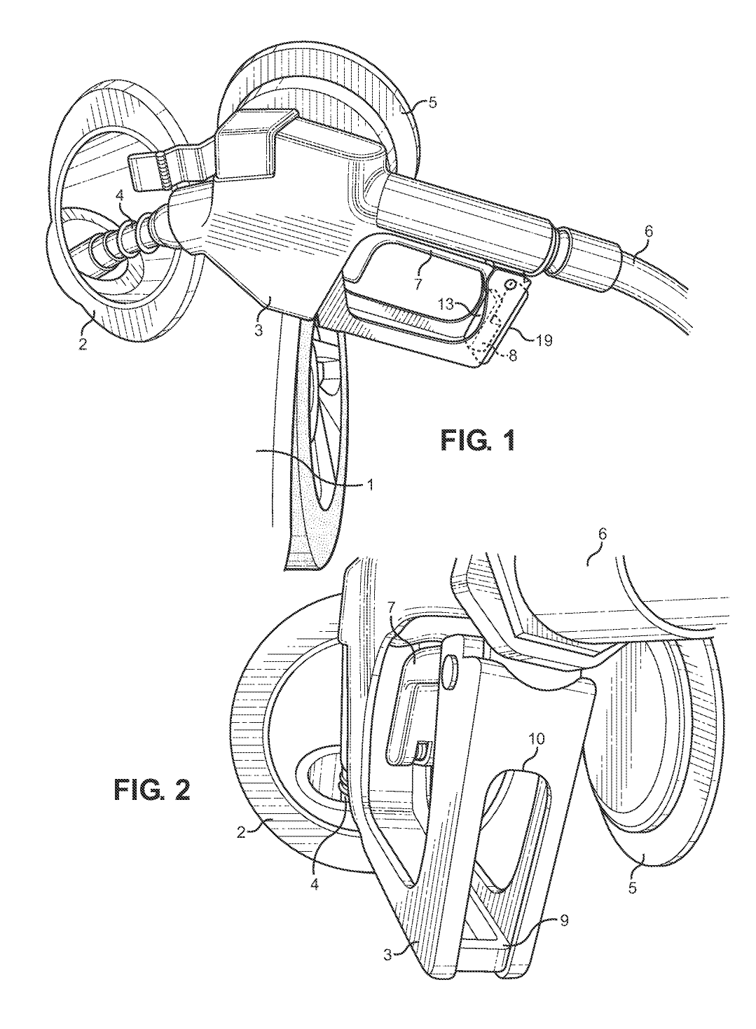

The gas/fuel nozzle holder 8 as shown in FIGS. 1, 3, 4, 5 and 6 is comprised of the back side 19, front side 13, top side 21, bottom side 15, top opening 16, key chain hole 14 and an optional key chain ring 11.

FIG. 1 illustrates the fueling process where a customers vehicle 1 would be located at a self-service gasoline station (not shown), the customer would then open their vehicle's fuel door 5, insert a gasoline-dispensing nozzle's 3 spout 4 into the vehicles gas tank opening 2. Once the gasoline-dispensing nozzles lever handle 7 is engaged in the open position, a gas/fuel nozzle holder 8 can be inserted into the rear portion of the gasoline-dispensing nozzle 3. During this process gasoline would flow from the gasoline-dispensing nozzles hose 6 through the spout 4 into the vehicles gas tank opening 2.

When the vehicle tank becomes filled, the fuel level trips the valve mechanism inside the gasoline-dispensing nozzle 3 so as to automatically shut off the fuel flow. The gas/fuel nozzle holder 8 is then removed and the gasoline-dispensing nozzle 3 is taken out of the vehicles gas tank opening 2 and is returned to its resting cradle 17.

The gas/fuel nozzle holder 8 maybe stored in the vehicles gas tank opening 2 for user ease of accessibility.

FIG. 2 is provided to show a closer look at a gasoline-dispensing nozzle 3 rear opening 10 and its respective bottom area 9 without the gas/fuel nozzle holder 8 being used.

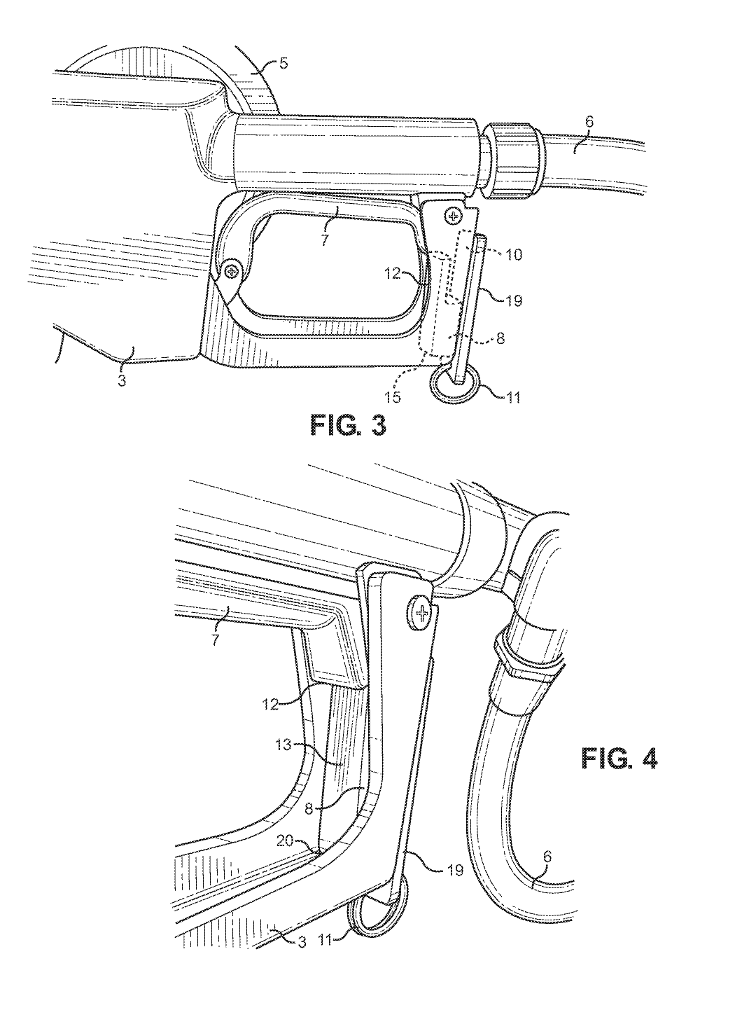

A deeper understanding of the invention claims can be viewed in FIGS. 3, 4 and 5. When the gas/fuel nozzle holder 8 is inserted into the gasoline-dispensing nozzle 3 the lever handle 7 must be squeezed to the engaged the fueling position first, then simultaneously while holding the gas/fuel nozzle holder 8 by its back side 19, the top side 21 of the gas/fuel nozzle holder 8 will be put into the rear opening 10 of the gasoline-dispensing nozzle 3 where the top opening 16 of the gas/fuel nozzle holder 8 straddles the rear opening 10. Once the top side 21 is inserted, then the bottom side 15 of the gas/fuel nozzle holder 8 can be position so that it is now resting on the rear openings bottom area 9. The meeting point of the bottom side 15 of the gas/fuel nozzle holder 8 and the rear openings bottom area 9 is referenced as the resting area 20. With the gas/fuel nozzle holder 8 inserted into the gasoline-dispensing nozzle 3 the lever handle 7 will meet the front side 13 of the gas/fuel nozzle holder 8 and will be held in place by the gas/fuel nozzle holder 8. The meeting point of the lever handle 7 and the front side 13 is referenced as lever handle contact area 12. Once the gas/fuel nozzle holder 8 has been inserted into the gasoline-dispensing nozzle 3 properly, the user may remove their hand from the lever handle 7 until the end of their fueling process begins.

When the user decides they are at the end of their fueling process, the fuel/gas nozzle holder 8 maybe removed by squeezing the lever handle 7 with their hand and then simultaneously pulling on the back side 19 of the gas/fuel nozzle holder 8 in a downward and outward direction away from the gasoline-dispensing nozzle 3. Once the fuel/gas nozzle holder 8 is completely removed the lever handle 7 may be released to its resting closed position. The gasoline-dispensing nozzle 3 may then be safely placed back into its resting cradle 17, which resides normally on the fuel filling station 22.

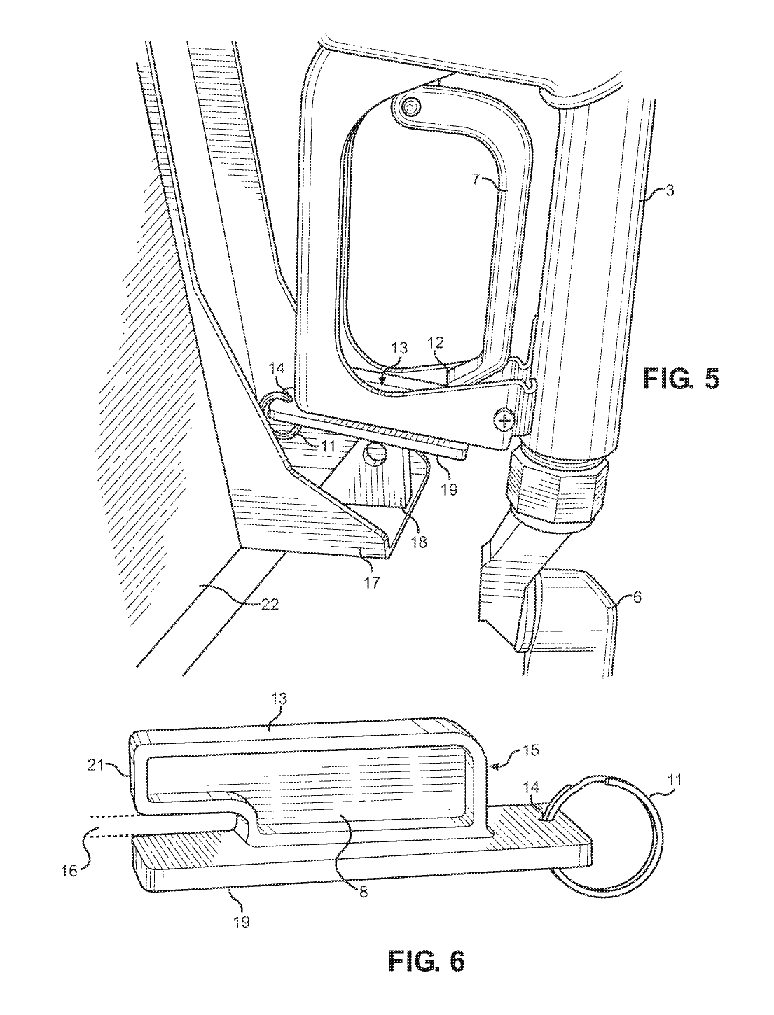

FIG. 5, another embodiment of the present invention is shown in which the gas/fuel nozzle holder 8 when inserted utilizes the rear opening 10 of a gasoline-dispensing nozzle 3 and positions the gas/fuel nozzle holder 8 back side 19 to cover the rear opening 10 completely. With the rear opening 10 being covered completely it does not allow the gasoline-dispensing nozzle 3 to be placed back into its respective resting cradle 17, because the resting cradle locating lock pin 18 that would normally penetrate the rear opening 10 of the gasoline-dispensing nozzle 3 is being obstructed from doing so.

In the event a gasoline-dispensing nozzle 3 falls while the gas/fuel nozzle holder 8 is engaged with a lever handle 7, the protrusion of the back side 19 engages the ground and its angulation disengages the gas/fuel nozzle holder 8 from the gasoline-dispensing nozzle 3 as a safety precaution.

FIG. 6 illustrates the gas/fuel nozzle holder 8 with an optional key chain ring 11 for user ease of accessibility.

While the invention has been illustrated and described in detail with drawings and foregoing description, it is understood that the same is not limited thereto, but is susceptible to changes and modifications as known to those skilled in the subject matter. Therefore, I do not wish to be limited to the details shown and described herein and intend to cover all such changes and modifications as are encompassed by the scope of the appended claims.

I claim as my invention:

1. used in conjunction with a said gasoline-dispensing nozzle during said fueling process; said gasoline-dispensing nozzle including said pump lever and said rear portion of the nozzle. A gas/fuel nozzle holder as said portable mechanism when inserted into the said rear portion of said gasoline-dispensing nozzle enables the nozzles said pump lever to disperse fuel in the open position with no additional manual input from an operator.

2. the invention of claim 1 wherein the said portable mechanism dimensions is determined by said rear portion of said gasoline-dispensing nozzle where said pump lever is engaged.

3. the invention of claim 1 wherein the said portable mechanism accesses the said rear portion of the said gasoline-dispensing nozzle.

4. the invention of claim 1 wherein the said portable mechanism is comprised of one solid piece.

5. the invention of claim 3 wherein the said portable mechanism can be inserted at anytime during the said fueling process.

6. the invention of claim 3 wherein the said portable mechanism can be removed at anytime during the said fueling process.

7. the invention of claim 3 wherein prohibits said gasoline-dispensing nozzle from being put back into its resting cradle without removing the said portable mechanism during the end of the said fueling process.

8. the invention of claim 4 wherein the said portable mechanism is comprised with an opening for receipt of a said key ring.

9. the invention of claim 4 wherein the said portable mechanism is comprised of any type of material, matter or medium.
